(19) United States
(12) Patent Application Publication
(10) Pub. No.: US 2024/0360005 A1
(43) Pub. Date: Oct. 31, 2024

(54) Systems and Methods for Separating Components of a Mixture

(71) Applicant: Battelle Memorial Institute, Richland, WA (US)

(72) Inventors: Leonard F. Pease, Richland, WA (US); Michael J. Minette, Kennewick, WA (US); Carolyn A. Burns, Richland, WA (US); Jason E. Serkowski, Richland, WA (US); Nathan R. Phillips, Kennewick, WA (US)

(73) Assignee: Battelle Memorial Institute, Richland, WA (US)

(21) Appl. No.: 18/649,674

(22) Filed: Apr. 29, 2024

Related U.S. Application Data
(60) Provisional application No. 63/462,596, filed on Apr. 28, 2023.
(60) Provisional application No. 63/522,819, filed on Jun. 23, 2023.

(51) Int. Cl. C02F 1/00; B07B 13/04

(52) U.S. Cl. CPC C02F 1/004; B07B 13/04; C02F 2301/028

(57) ABSTRACT

Systems for separating components of a mixture are provided which can include: a conduit system having at least one linear section including a length of opposing sidewalls defining a volume configured to receive a flow of mixed materials entering along a proximate end of the length and exiting along a distal end of the length; and a tortured path defining at least one series of members extending in line across the volume from one sidewall of the volume and inwardly toward the distal end defining an angle other than normal from the one sidewall.

Methods for separating components of a mixture are provided which can include providing a mixture of components into the tortured path to separate larger components from smaller components of the mixture and concentrate the larger components toward an opposing sidewall of the conduit.

### CROSS REFERENCE TO RELATED APPLICATION

This application claims priority to and the benefit of U.S. Provisional Patent Application Ser. No. 63/462,596 filed Apr. 28, 2023, entitled “Modular Inline Particle Fractionators” and U.S. Provisional Patent Application Ser. No. 63/522,819 filed Jun. 23, 2023, entitled “Targeted Particle Fractionation Technology”, the entirety of each of which is incorporated by reference herein.

### STATEMENT AS TO RIGHTS TO DISCLOSURES MADE UNDER FEDERALLY-SPONSORED RESEARCH AND DEVELOPMENT

This invention was made with Government support under Contract DE-AC05-76RL01830 awarded by the U.S. Department of Energy. The Government has certain rights in the invention.

### TECHNICAL FIELD

The present disclosure relates to systems and methods for separating components of a mixture. In particular embodiments, the systems and methods can operate as particle fractionators.

### BACKGROUND

Some methods of particle-size separation involve particle fractionation which may be accomplished with filtration or the use of screens.

It is still desirable to remove large particles from processing streams. Techniques to increase or decrease concentration of components within a mixture over a range of industrial applications would be beneficial. Techniques to perform these separations at low pressure drops would also be beneficial.

Mixtures can include particle concentrations in fluid (liquid or otherwise) and changing or altering the composition of slurries in process streams can have broad industrial applications. Industrial applications range from processing of nuclear wastes, concentrating isotopes, harvesting algae, removing silica from geothermal power plants, processing adsorbants that collecting rare earth materials or environmental contaminants, removing particles from water sources, removing particulates from food processing; can benefit from advances in this area.

Particle separation is a vital need for a variety of process intensive industries. For example, silica particles have to be removed from geothermal processes to permit downstream chemistries to extract lithium and rare earth metals; blood cells have to be removed from whole blood donations to prepare plasma; sand, proppant and other particles have to be removed from hydrocarbon streams; solids have to be removed from nuclear waste streams to separate low- and high-level waste streams from each other; and algae has to be harvested from concentrated algal suspensions. Industrial equipment to perform particle separation is typically slow, bulky, and unable to be operated in a dynamic manner. For example, clarifiers and open-air waste ponds and pits simply wait for gravity to settle particles so that the particle depleted fluid can be processed. Slow processes lead to large expensive processing equipment and large environmental footprints. Processes that need faster throughput often rely on centripetal forces (e.g., centrifuges) that often have moving parts or are smaller but still bulky. To intensify slurry processes, new approaches remain essential.

The present disclosure provides heretofore undisclosed systems and methods for separating components of mixtures.

### SUMMARY

Systems for separating components of a mixture are provided. The systems can include: a conduit system including at least one linear section, the at least one linear section including a length of opposing sidewalls defining a volume configured to receive a flow of mixed materials entering along a proximate end of the length and exiting along a distal end of the length; and a tortured path within the volume of the at least one linear section, the tortured path defining at least one series of members extending in line across the volume from one sidewall of the volume and inwardly toward the distal end defining an angle other than normal from the one sidewall.

Methods for separating components of a mixture are also provided. The methods can include providing a mixture of components into a tortured path within a volume of at least one linear section of a conduit, the tortured path can include at least one series of members extending in line across the volume from one sidewall of the volume and inwardly toward the distal end defining an angle other than normal from the one sidewall, the tortured path separating larger components from smaller components of the mixture to concentrate the larger components toward an opposing sidewall of the conduit.

### BRIEF DESCRIPTION OF DRAWINGS

The patent or application file contains at least one drawing executed in color. Copies of this patent or patent application publication with color drawing(s) will be provided by the Office upon request and payment of the necessary fee.

Embodiments of the disclosure are described below with reference to the following accompanying drawings.

FIG. 1 is a system for separating components of a mixture according to an embodiment of the disclosure.

FIG. 2 is a system for separating components of a mixture according to an embodiment of the disclosure.

FIG. 3 is a depiction of a system for separating components of a mixture according to an embodiment of the disclosure.

FIG. 4 is another system for separating components of a mixture according to an embodiment of the disclosure.

FIG. 5 is a depiction of a system for separating components of a mixture according to an embodiment of the disclosure.

FIG. 6 is another system for separating components of a mixture according to an embodiment of the disclosure.

FIG. 7 is another view of the system of FIG. 6 for separating components of a mixture according to an embodiment of the disclosure.

FIG. 8 is another view of the systems of FIGS. 6 and 7 for separating components of a mixture according to an embodiment of the disclosure.

FIG. 9 is another system for separating components of a mixture according to an embodiment of the disclosure.

FIG. 10 is another system for separating components of a mixture according to an embodiment of the disclosure.

FIG. 11 is another system for separating components of a mixture according to an embodiment of the disclosure.

FIG. 12 is another system for separating components of a mixture according to an embodiment of the disclosure.

FIG. 13 is another system for separating components of a mixture according to an embodiment of the disclosure.

FIG. 14 is another system for separating components of a mixture according to an embodiment of the disclosure.

FIG. 15 is a view of the system of FIG. 14 for separating components of a mixture according to an embodiment of the disclosure.

FIG. 16 is a view of the systems of FIGS. 14 and 15 for separating components of a mixture according to an embodiment of the disclosure.

FIG. 17 is another system for separating components of a mixture according to an embodiment of the disclosure.

FIG. 18 is a depiction of a system test loop utilized during evaluation of the systems of the present disclosure.

FIG. 19 depicts data generated testing systems of the present disclosure using the test loop of FIG. 18.

### DESCRIPTION

This disclosure is submitted in furtherance of the constitutional purposes of the U.S. Patent Laws “to promote the progress of science and useful arts” (Article 1, Section 8).

The present disclosure provides systems and methods for separating components of a mixture. These systems can be configured as in-pipe particle fractionation technologies that can be used across the spectrum from laboratory to industrial scales.

The systems can be part of mesofluidic systems and/or use an array of staggered posts as configured in a bump array for Newtonian slurry conditions. The systems can be utilized to minimize plugging and inline pressure build ups that are caused by filters and screens.

The systems and methods of the present disclosure can drive some components toward a sidewall of the conduit. In some implementations, the conduit can be arranged in related to gravity and the system and methods can drive some components in the direction of gravity, or the bottom.

After passing a tortured path of the system (which may block particles directly or divert particles due to flow patterns), the flow can be divided with some components such as larger particles in the lower stream and the particle depleted flow exiting the upper stream.

In accordance with example implementations, at least two mechanisms may be operative when implementing the systems and/or methods of the present disclosure. First, components such as all large particles may migrate toward a sidewall or even into an express lane with no recovery of the larger particles back into the rest of the flow stream. Second, the systems or methods may almost laminarize the flow into the express lane. When the flow re-expands, there can be a vertical upward flow that may compete with the gravitational force on the particles to set their position or distribution of positions within the flow streams. This later mechanism may open up the potential to determine the cutoff location. Likely both mechanisms have some influence that may vary with flow rate (please note that these flow obstacles are distinctive from those of the mesofluidic separators).

In these flow through systems and methods, the temporal dimension can be exchanged for a spatial dimension so that the degree of separation varies as a function of distance from the end of the flow obstacles with smaller particle exiting proximate one sidewall or on top and larger particles preferentially exiting proximate a sidewall opposing the one sidewall or closer to the express lane.

This technology can be used to change the particle concentration of flow streams as described above. For example, the disclosed technologies may be used to remove large hydraulic fracturing sands prior to more precise particle separations in the spirit of an oversized material removal gate. The disclosed technologies may be used to remove large particulate from waste water streams so that downstream flow may be further processed into usable water (e.g., agricultural, potable, industrial grade, etc.). Additional examples remain within the scope and intent of this disclosure.

These systems and/or methods can be implemented as particle removal systems that operate at high throughput, that are modular, and can be inserted inline into existing piping systems, and therefore are compelling across a number of applications as described above.

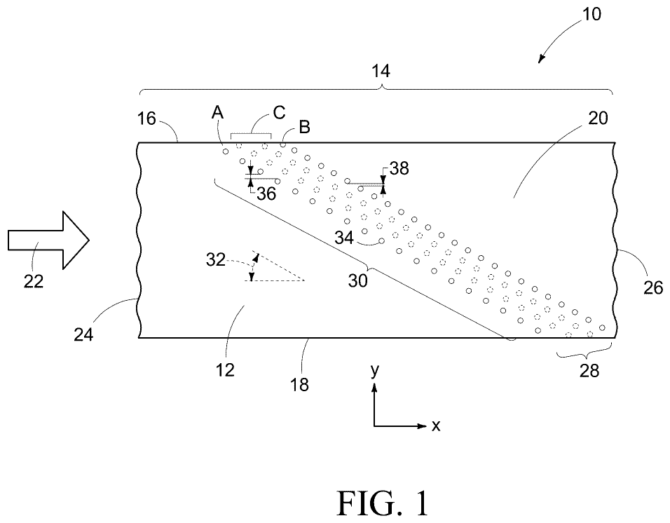

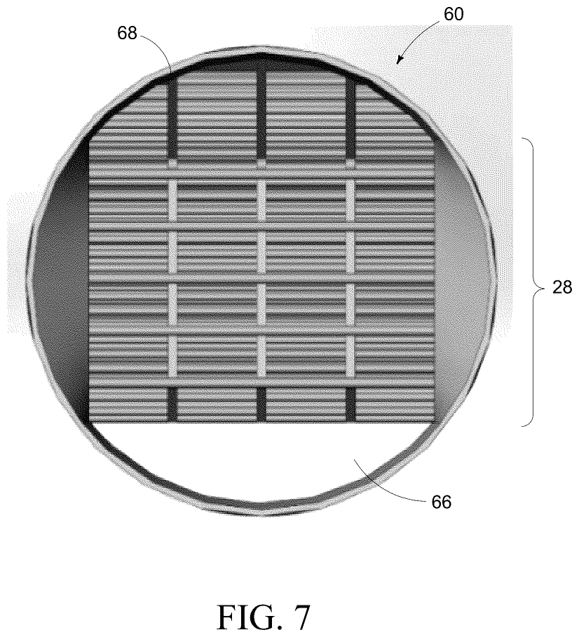

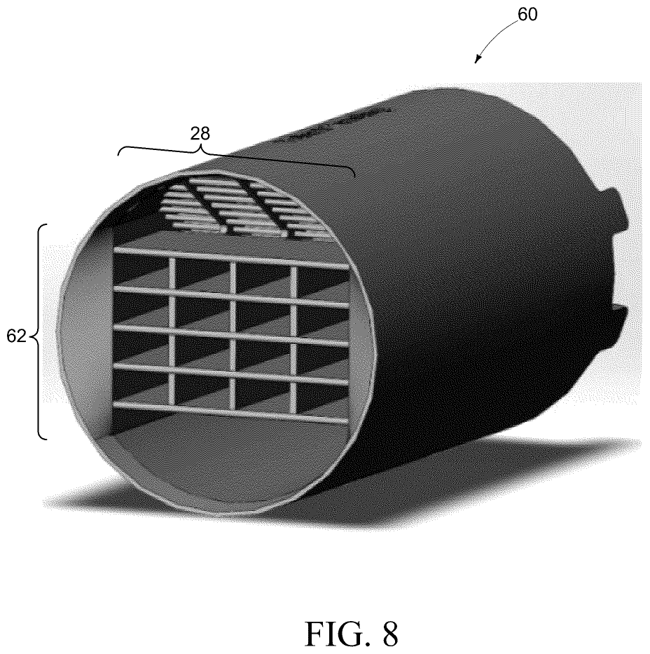

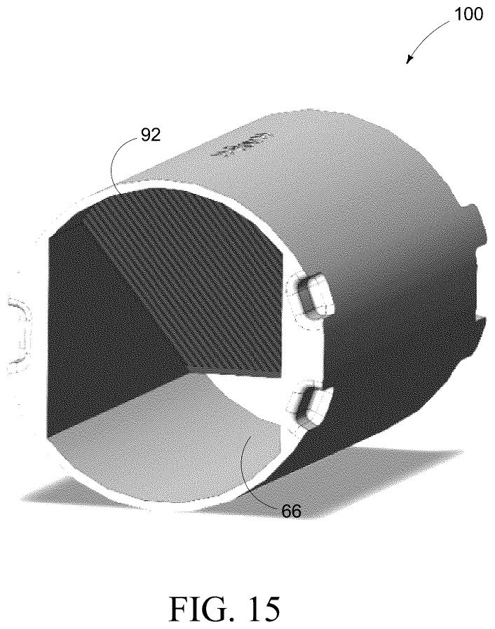

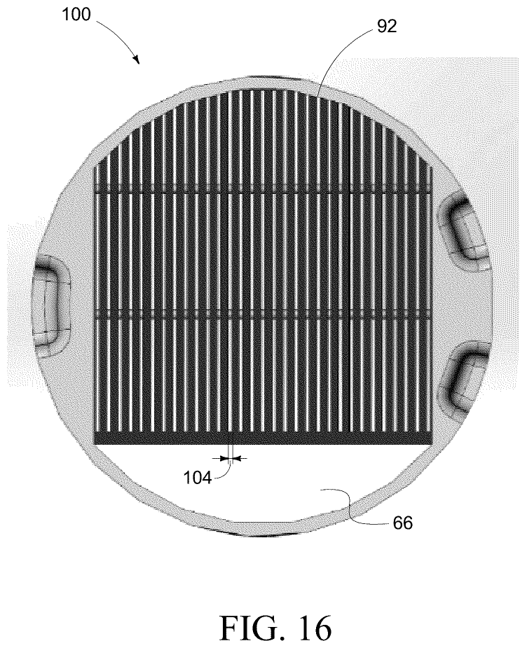

The present disclosure will be described with reference to FIGS. 1-19. Referring first to FIG. 1, a system 10 for separating components of a mixture is depicted. System 10 can include a conduit system 12 defined by at least one linear section 14. Linear section 14 can include a length of opposing sidewalls (16 and 18) defining a volume 20 configured to receive a flow of mixed materials 22 entering along a proximate end 24 of the length and exiting along a distal end 26 of the length. In accordance with example implementations, at least sidewall 18 can be aligned normal to body forces such as gravity. While not shown here, sidewall 18 may be aligned other than parallel to these body forces. In some implementations, sidewall 18 can extend normal to these forces. In other implementations, both sidewalls 16 and 18 can be parallel to one another and accordingly aligned in relation to body forces.

Materials 22 can proceed through system 10 along the X-axis for example. Material 22 can be flowable and be a mixture of components having different physical properties (e.g., size, density, condensed (liquid or solid), non-condensed). The materials can include non-solid particles such as algae and/or oil droplets. The mixture can include one or more of fluids, fluids and solids, liquids, liquids and solids, liquids and cells, liquids and flocculants, solids, and/or emulsificants. Accordingly, the mixture can include components of different phases. Solids within the mixture can include one or more of sand, oil, sticky particles that agglomerate, salt cake simulant, abrasive polydispersed particles, slurry with particles spheres, irregular particles, silica, oil-water mixture with solid particles, algae, and/or emulsions. The materials can include a solution that includes gaseous materials in the form of bubbles within the solution. Material 22 can be provided to system 10 as a relatively uniform mixture or not.

System 10 can also include a tortured path 28 within volume 20 of linear section 14. Tortured path 28 can include at least one series of members 30 extending in line across volume 20 from one sidewall 16 of volume 20 and inwardly toward distal end 26 defining an angle 32 other than normal from one sidewall 16. While the series of members can extend in line or can be aligned to define a direction and angle in relation to sidewall 16, a person of ordinary skill will recognize that perfect alignment is not necessary, but a linear average is sufficient to define the direction and angle.

In accordance with example implementations, one series A of members can be configured as a plurality of posts 34. Posts 34 can be defined by curved or straight exterior portions. Individual ones of posts 34 can extend between opposing sidewalls of the conduit and define individual cross sections, each of the cross sections being in line across volume 20. Another series B, for example, can be provided lateral of series A. Spacing 36 between posts of series A can be larger than spacing 38 between posts of series B.

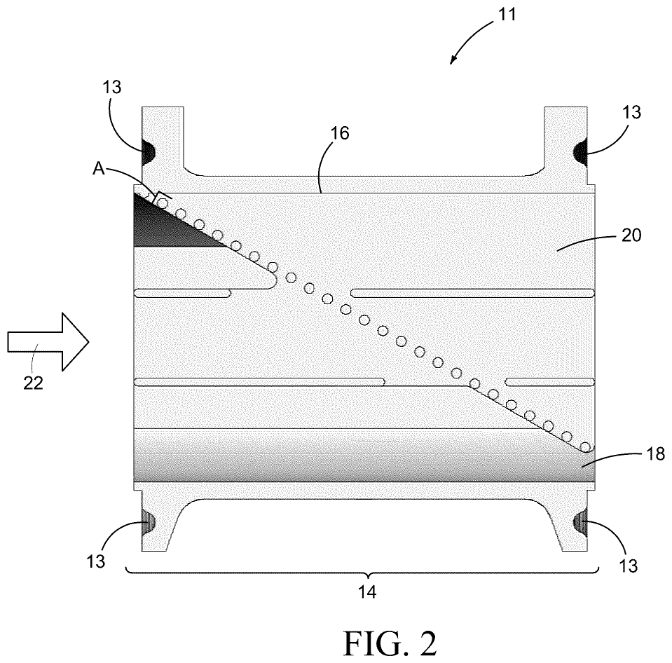

Referring next to FIG. 2, system 11 is shown that includes a single series A. Accordingly, this single series extends from sidewall 16 within volume 20 of linear section 14. System 11 is configured to receive material 22. System 11 includes coupling interfaces 13 that can be complimentarily configured to engage one or more other systems. All systems of the present disclosure can be so configured.

As shown in the Figs and described herein the systems can be oriented to provide particles toward the lower portion of the system and provide for the separation of those lower particles from the mixture provided to the system. The system can provide for multiple streams of mixtures of components. These streams can include different portions of a permeate that proceeded beyond or through the tortured path as well as different portions of a concentrate. These streams can be individually captured with structures down flow of the tortured path that are aligned to receive portions of the flow. For example, channels can be aligned with most or specific portions of the permeate, while other channels are aligned with most or specific portions of the concentrate.

Additionally, the system can be configured to separate buoyant components of the mixture; for example, bubbles of different sizes and buoyancy. While the system is shown in having the tortured path extending at a declining angle in relation to the left to right flow, the system can be inverted. In this inverted configuration, with the tortured path ascending in relation to the left to right flow, components that are buoyant in relation to the mixture can form a concentrate at the upper portion of the system while the permeate can include other components of the mixture. In this configuration, bubbles of specific sizes and/or buoyancy can be separated from the mixture. Accordingly, as the tortured path extends and ascends from the lower portion of the system toward the upper portion in this configuration, an upper expressway may be provided, and this expressway may be part of the upper portion of the system or an opening through an upper portion of the system. In accordance with example implementations, when configured with an ascending angle, the system can also be oriented at an angle in relation to body forces (gravity, etc.). For example, the entire system can be arranged other than normal to body forces with the system arranged at an ascending or descending angle.

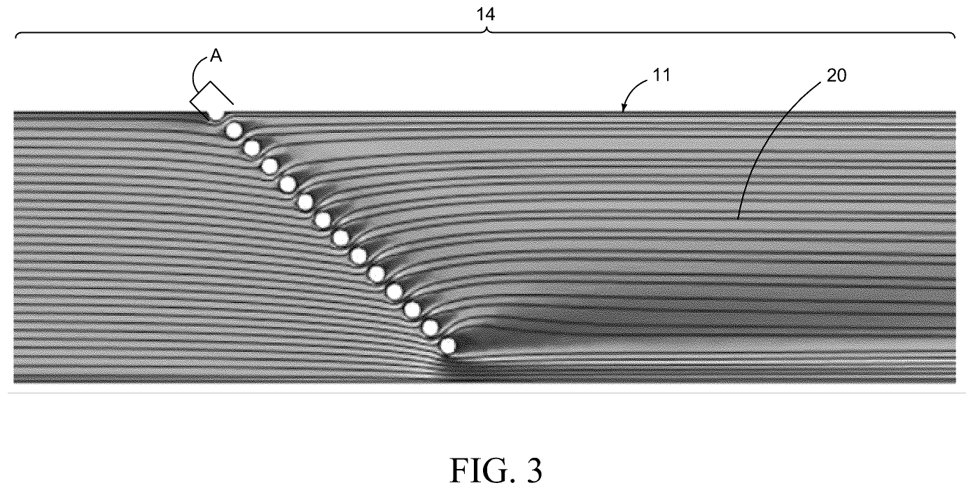

Referring next to FIG. 3, a color depiction of system 11 in process is shown. Flow is at 5 m/s from left to right. The blue low velocity zones behind the posts allow oversized particles to move downward while the smaller particles flow along the yellow/green flow lines through the volume. As the flow reestablishes across length 14, smaller particles follow the flow streams to spread out across the full vertical spread of the conduit in contrast to the larger particles for which gravity competes with the reestablishing vertical flow to keep these larger particles lower in the flow channel. Accordingly, particles in the flow can be driven to one side of a flow channel and then the flow field is changed allowing the smaller particles to migrate away from the side of the channel first, and then the larger particles migrate away so that progressively larger particles exit the system.

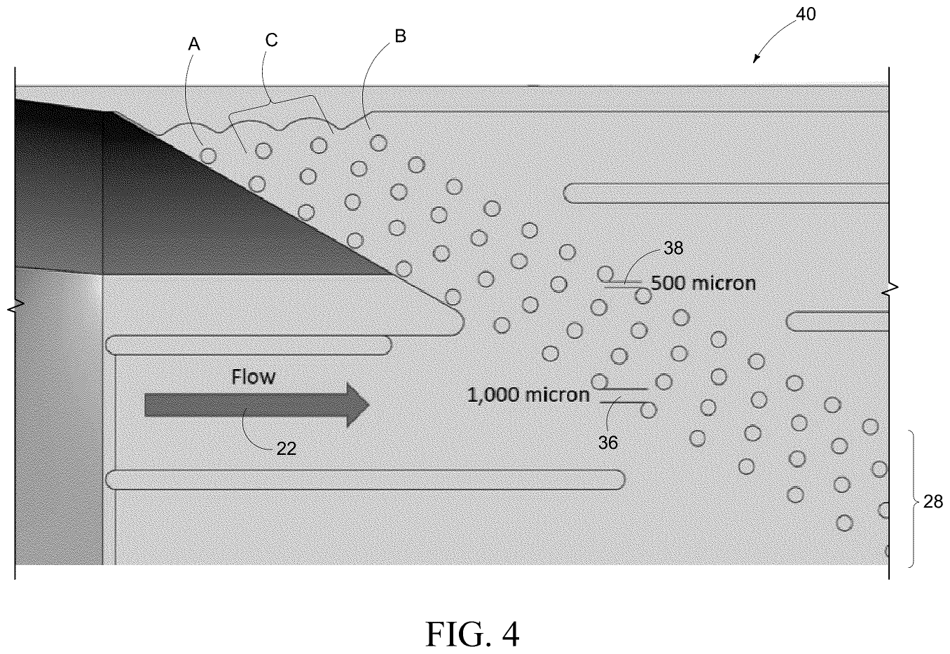

Referring next to FIG. 4, system 40 is shown (e.g., Bump Array Staged (BAS) Particle Fractionator) and can provide direct interference of oversized particles within the slurry flow stream 22. As shown in FIG. 4, posts are spaced so that vertical height 36 to flow stream 22 can be slightly smaller than the particle sizes to be removed. In accordance with example implementations, spacing between posts of series A is at least 1000 microns. Spacing between posts of series B can be 500 microns or less than 1000 microns. Accordingly, a ratio of the spacing between the posts of series A and series B can be at least 2:1.

Systems 10 and 40 can include at least one intermediate series C between series A and B. Spacing of any of intermediate series C can be equal to the series to which it is most lateral, and multiple intermediate series between series A and B can be provided. As an example, spacing of at least one of multiple intermediate series C can be equal to the spacing of series A. As another example, spacing of at least one of multiple intermediate series C can be equal to the spacing of series B.

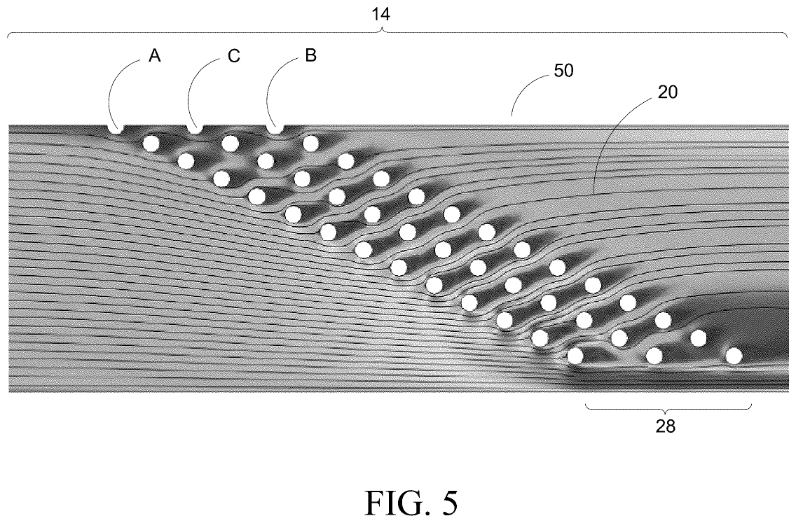

Referring to FIG. 5, a color depiction of system 50 in process is shown. Flow is at 5 m/s from left to right. The blue low velocity zones behind the posts allow oversized particles to move downward while the smaller particles flow along the yellow/green flow lines through the volume. As the flow reestablishes across length 14, smaller particles follow the flow streams to spread out across the full vertical spread of the conduit in contrast to the larger particles for which gravity competes with the reestablishing vertical flow to keep these larger particles lower in the flow channel. Accordingly, particles in the flow can be driven to one side of a flow channel and then the flow field is changed allowing the smaller particles to diffuse away from the side of the channel first, and then the larger particle diffuse away so that progressively larger particles exit the system.

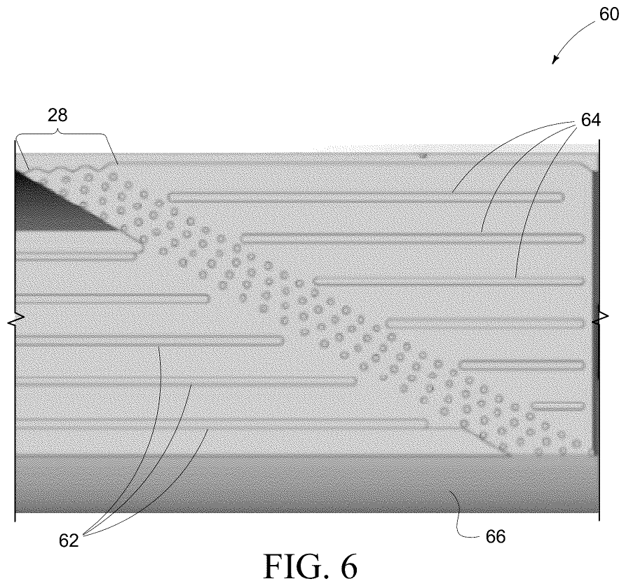

FIGS. 6, 7, and 8 depict system 60 that includes tortured path 28 and turbulence reduction sections 62 and 64 as well as expressway 66. Flow is from left to right and front to back.

System 60 as tested was 2.90 in. in diameter with a length of 4.764 in. and having an expressway 62 height at the bottom was 0.5 in. The vertical spacing between the edge of the posts was 1000 microns for the first series, 800 microns for the second series, 600 microns for the third series, and 500 microns for the last series. A rectangular grid 62 was used before the BAS pins to reduce turbulence. The view of the BAS tested is shown in FIGS. 6, 7, and 8. The series of posts were 3D printed at a 60° angle to the slurry flow 22 to reduce plugging and expedite particle flow to the expressway.

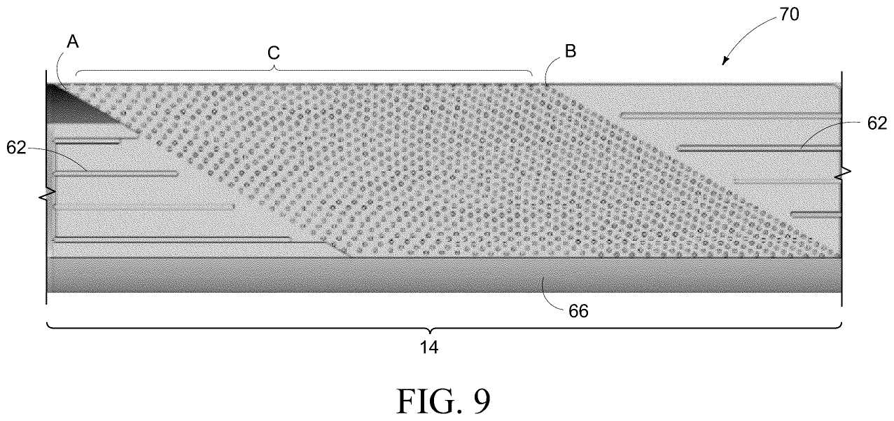

System 70 of FIG. 9 depicts multiple intermediate series configuration with the flow direction from the left to the right. In this example, the spacing between posts in each row starts at 700 microns on the left and reduces in spacing to 600, 400, 200, 100, 70, and then to 50 microns on the right. System 70 includes expressway 66.

In accordance with example implementations, length 14 can be relatively short (less than 1 foot) when compared with other separation configurations. The series of posts A, B, and C for example can be angled at, for example sloped 60° to flow 22 and particle sizes can be sequentially removed (>1,000 microns, >800 microns, >600 microns, and >500 microns).

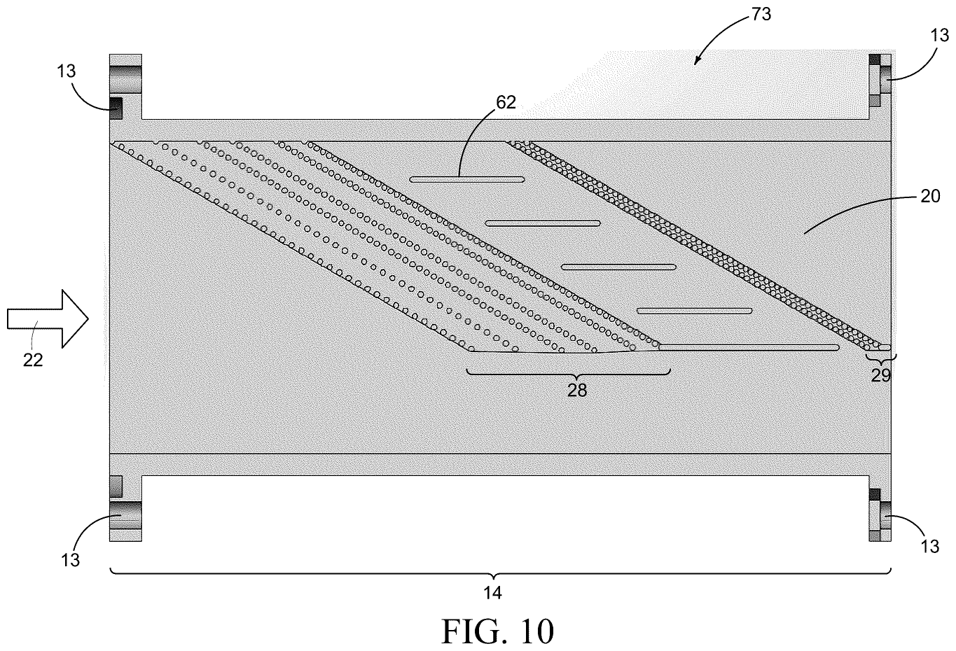

Referring next to FIG. 10, system 73 is shown that includes tortured path 28 separated from another tortured path 29 by a turbulence reduction structure 62. While shown with multiple series in each path, with each path having different spacing, additional implementations, include paths of a single series are contemplated.

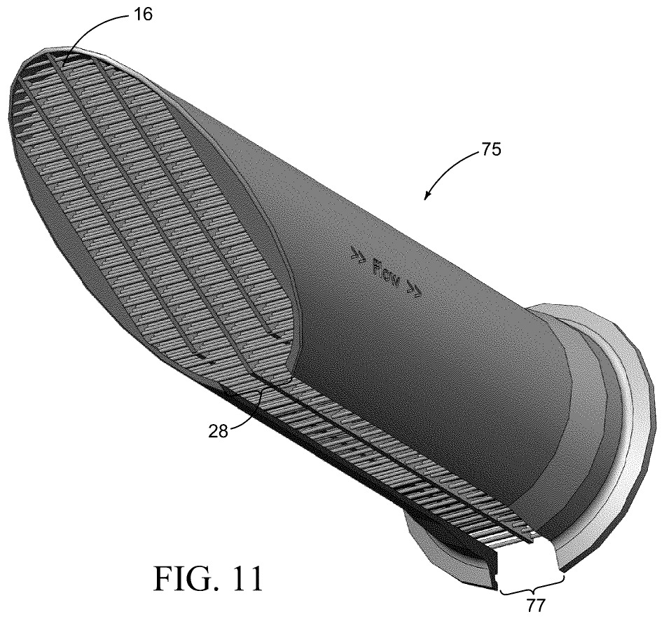

Referring next to FIG. 11, system 75 is provided that includes an open expressway 77. Accordingly, at least portion of sidewall 18 is removed and rather than traveling within the conduit, separated materials can drop out through opening 77.

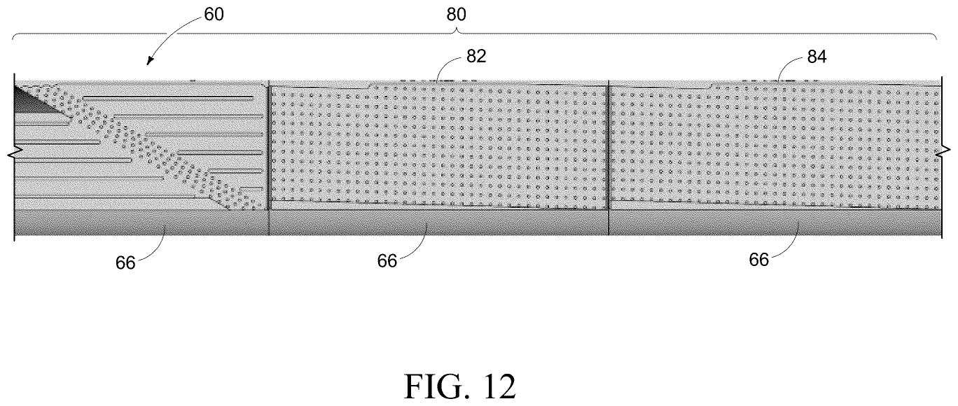

System 80 of FIG. 12 provides an example of system 60 operatively engaged with a mesofluidic system or systems 82 and/or 84 (MFS, as shown and described in US Patent Application Publication No. US 2020/0306798 published Oct. 10, 2020, which is hereby incorporated by reference herein). While shown with two additional systems 82 and 84, many more systems can be added. This particular implementation can protect mesofluidic separators from large particles. Implementation of these systems can remove >97% of particles in less than 1 foot of the systems of the present disclosure (i.e., 10, 11, 40, 50, 60, 70, 73, 75, 90, 100, and/or 110) at flow rates of 100-220 gpm with minimal pressure drop losses. Systems 10, 11, 40, 50, 60, 70, 73, 75 can be referred to as a Bump Array Staged (BAS) Particle Fractionator (BASPF).

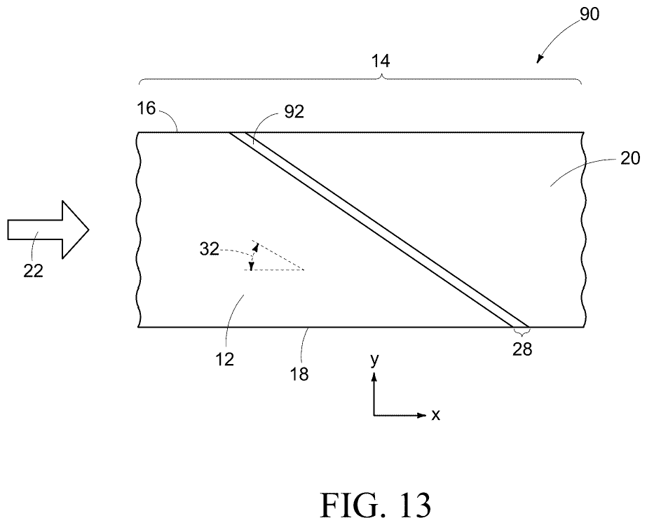

Referring next to FIG. 13, system 90 is depicted that includes tortured path 28 within volume 20. Path 28 can be configured as a plurality of linear members 92 configured as a grate having individual linear members extending along as a series at an angle 32 other than normal to flow 22. Systems 90, 100, and/or 110 can be referred to as an Angled Grated Gate (AGG) Particle Fractionator (AGGPF).

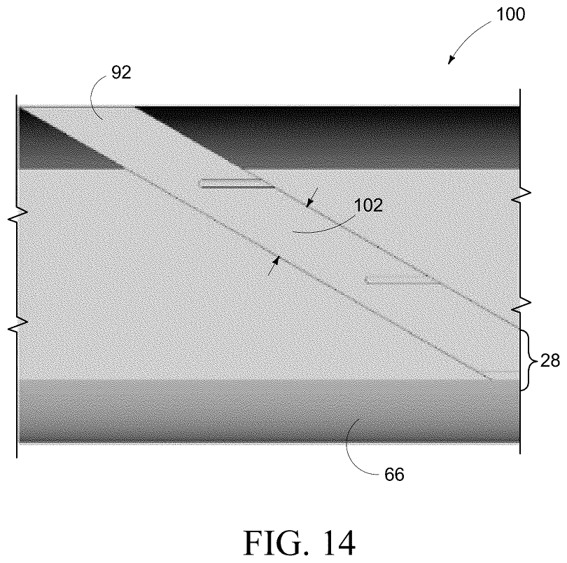

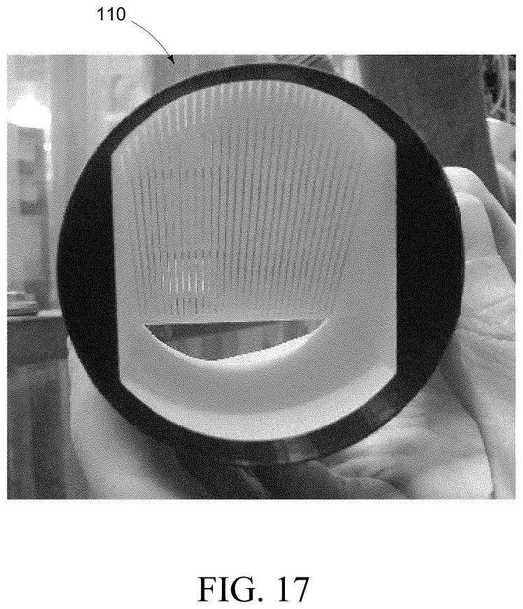

FIGS. 14-16 depict system 100 having the views flowing into the system. System 100 is configured for particle maximum diameter: 8 mesh (2.38 mm); particle minimum cutoff: 30 mesh (0.595 mm); conduit internal diameter: 2.90 in. (nominal three-inch schedule 80); linear member width 102 (direction of flow): 1.2 mm; gap 104 between linear members: 0.55 mm; expressway width: 0.50 in.; and angle 32: 60°. Referring to FIG. 17, system 110 is provided as an additional example embodiment.

Systems 90, 100, and 110 can leverage controlled spaced linear members as the in line series to move targeted particles to an expressway so that oversized materials can be rapidly removed from the conduit.

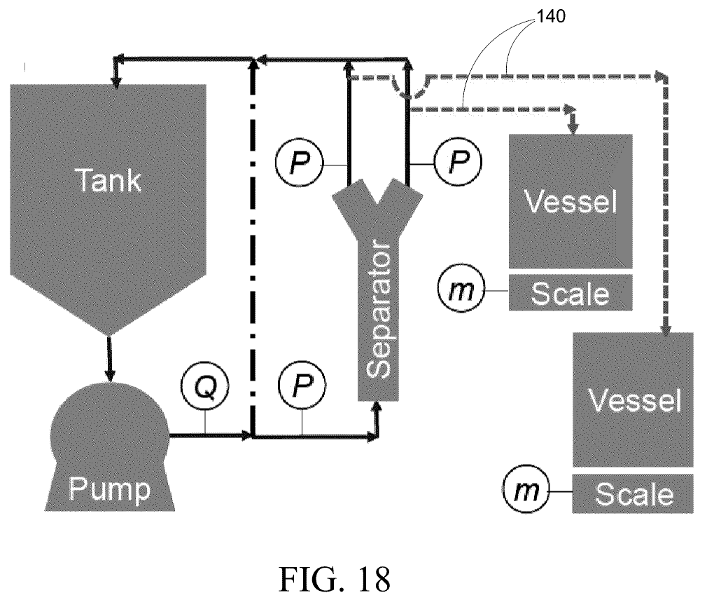

Referring to FIG. 18, configurations of the systems were tested. As part of that testing, a mixture of components was prepared (sands slurry).

Sand having a density of 2.5-2.8 g/cc after 30 mesh sieving was provided.

FIG. 18 depicts an embodiment of the multiphase test evaluation loop layout used for the proof of principle testing. Dashed lines 140 note the diversion pipes used during sampling and components are listed in Table 1.

TABLE 1
Instrumentation

| Instrument | Model |
|---|---|
| Pump | Georgia Iron Works slurry pump |
| Flow (Q) | Micro-Motion Coriolis F300S355CQBAGZ |
| Sample time | Digital stopwatch |
| Tank | 460-gallon poly |
| Scales (m) | Combies3 Sartorius Scale |

The testing in the high bay involved three test sequences. For each sequence the pressure was measured as a function of the flow rate for each test. Tests occur in pairs with one at 50 gpm (the minimum design flow rate) and one at the maximum flow rate the pump can generate. Test sequences are shown in Table 2.

TABLE 2
Flow Velocities and Turbulence

| | Target | Actual | Flow | Pipe Reynolds |
|---|---|---|---|---|
| | Flow | Flow | Velocity | Number (all |
| Design | Rate | Rate | @ ID 2.9 in. | Turbulent) |
| Whale Tail_{(control)} | Maximum | 241 gpm | 3.50 m/s | 2.6 × 10⁵ |
| BAS | Design | 120 gpm | 1.74 m/s | 1.3 × 10⁵ |
| BAS | Maximum | 215 gpm | 3.13 m/s | 2.3 × 10⁵ |
| AGG | Design | 68 gpm | 0.99 m/s | 0.7 × 10⁵ |
| AGG | Maximum | 143 gpm | 2.08 m/s | 1.5 × 10⁵ |

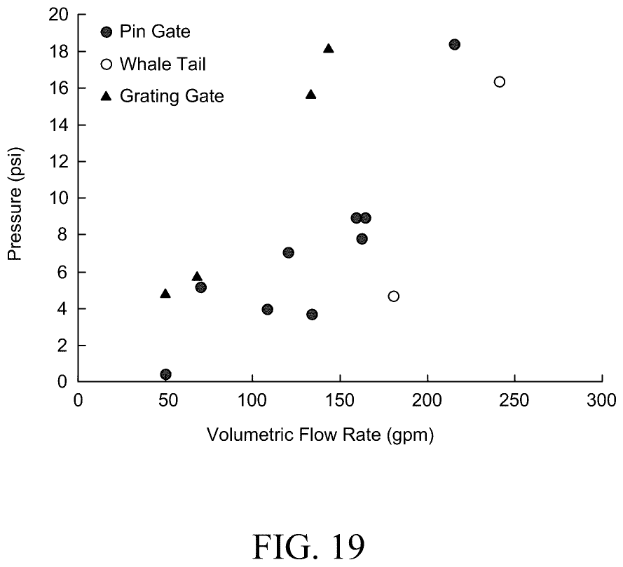

FIG. 19 shows pressure drop versus entering flow rate for the particle fractionator technologies. The whale tail is the divider after all the devices tested and provides a system baseline condition.

The success metric is the fraction of large particles (>30 mesh) being absent from the permeate lane. If the particle fractionator were perfect, this value would be 100%. If the particle fractionator is ineffective, then the success metric of the particle fractionator is the same as that of the whale tail alone. Gravity alone provides some large particle enrichment to the open pipe invert.

In this set of configurations, the BAS can be more effective at removing large particles. The AGG is nearly as effective as the BAS, but the AGG operates with a higher pressure drop as shown in FIG. 19. The results are in Table 3.

TABLE 3
Performance Results for Oversized Particle
Removal by Device and Solids Concentration.

| | Actual Sand | Target | Actual | Flow | |
|---|---|---|---|---|---|
| | Concen- | Flow | flow | Rate | Success |
| Design | tration | Rate | Rate | Split* | Metric ** |
| Whale Tail | 1.13 wt % | Maximum | 241 gpm | 61% | 85.66% |
| control | | | | | |
| BAS | 2.24 wt % | Design | 120 gpm | 55% | 99.75% |
| BAS | 1.31 wt % | Maximum | 215 gpm | 53% | 99.95% |
| AGG | 1.08 wt % | Design | 68 gpm | 19% | 99.83% |
| AGG | 1.22 wt % | Maximum | 143 gpm | 33% | 97.24% |

*by mass
** fraction by mass in open pipe invert on a mass basis

In accordance with example implementations, over 99% of the targeted oversized particles were removed from the slurry stream at industrial flow rates ≥120 gpm. In other implementations, over 97% of the targeted oversized particles from the slurry stream at industrial flow rates ≥68 gpm.

Each of the embodiments of the fractionators in the table below can be inserted into the test loop and use the same test particles. Tests used an approximately 8 gallon tank filled to approximate 7 gallons with water (added to keep the tank level approximately constant) and particles (added at the beginning of a test). Water from the tank flowed through a centrifugal pump via 0.5 inch tubing. After passing through a pressure relief valve, a flowmeter, and then a pressure gauge, flow entered the fractionator device. Various embodiments of the fractionator have multiple or single rows of pins, and various embodiments of the fractionator have flow straighteners (turbulence reducers) in front of or behind the rows of posts as described in Table 4 below. Flow from the fractionator left via either a lower exit termed and express lane or via an upper exit termed a permeate (even though there is no membrane through which to permeate). The flow through the express lane proceeded through a 0.25 inch Swagelok ball valve set to approximately 10% of the exiting flow. Flow then continued back to the tank to complete the loop. Similarly, the permeate flow (the remainder of the flow not proceeding through the express lane ˜90%) proceeded through 0.375 inch tubing back to the tank. Both flows were sampled within the tank at the tube exits. For these tests, the pump was operated at full power. The system was angled downward at an angle of ˜30 degrees to horizontal or normal to body forces to prevent the formation of fixed beds. The simulant used for each test was 120 g of sand, which had been sieve cut to between 150 microns and 850 microns.

TABLE 4

| | | | | Express | Express | | | Fraction |
|---|---|---|---|---|---|---|---|---|
| | | | | Lane | Lane Wet | Express | | Flow |
| | Total | Total | Sample | Liquid | Solid | Lane | Permeate | Through |
| | Flowrate | Flowrate | Time | Mass | Mass | Flowrate | Flowrate | Permeate |
| | gpm | mL/min | s | g | g | mL/min | mL/min | — |
| Multi-Row | 2.7 | 10221 | 15 | 448 | 2.8 | 1792 | 8429 | 82.5% |
| Fractionator | | | | | | | | |
| With Flow | | | | | | | | |
| Straighteners | | | | | | | | |
| Single-Row | 2.7 | 10221 | 15 | 444.7 | 7.7 | 1778.8 | 8442 | 82.6% |
| Fractionator | | | | | | | | |
| With Flow | | | | | | | | |
| Straighteners | | | | | | | | |
| Single-Row | 2.7 | 10221 | 15 | 455.8 | 7.5 | 1823.2 | 8397 | 82.2% |
| Fractionator | | | | | | | | |
| With Only | | | | | | | | |
| Entry Flow | | | | | | | | |
| Straightener | | | | | | | | |

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

1. A system for separating components of a mixture, the system comprising:
a conduit system comprising at least one linear section, the at least one linear section comprising a length of opposing sidewalls defining a volume configured to receive a flow of mixed materials entering along a proximate end of the length and exiting along a distal end of the length; and
a tortured path within the volume of the at least one linear section, the tortured path comprising at least one series of members extending in line across the volume from one sidewall of the volume and inwardly toward the distal end defining an angle other than normal from the one sidewall.

2. The system of claim 1 wherein the one series of members comprises a plurality of posts, individual ones of the posts extending between opposing sidewalls of the conduit and defining individual cross sections, each of the cross sections being in line across the volume.

3. The system of claim 2 further comprising another series lateral of the one series.

4. The system of claim 3 wherein spacing between the posts of the one series is larger than the spacing between the posts of the other series.

5. The system of claim 4 wherein spacing between the posts of the one series is at least 1000 um.

6. The system of claim 5 wherein spacing between the posts of the other series is less than 1000 um.

7. The system of claim 4 wherein a ratio of the spacing between the posts of the one series and the other series is at least 2:1.

8. The system of claim 2 further comprising at least one intermediate series between the one and the other series.

9. The system of claim 8 wherein spacing of the one intermediate series is equal to the one or the other series.

10. The system of claim 2 further comprising multiple intermediate series between the one and the other series.

11. The system of claim 10 wherein spacing of at least one of the multiple intermediate series is equal to the spacing of the one series.

12. The system of claim 10 wherein spacing of at least one of the multiple intermediate series is equal to the spacing of the other series.

13. The system of claim 1 further comprising a turbulence reduction section operatively aligned with the proximate end of the length of sidewalls.

14. The system of claim 1 further comprising a turbulence reduction section operatively aligned with the distal end of the length of sidewalls.

15. The system of claim 1 further comprising support members normal to the posts.

16. The system of claim 1 further comprising an expressway defined by at least a portion of the sidewalls.

17. The system of claim 16 wherein the series terminates at the expressway.

18. The system of claim 16 wherein at least a portion of the sidewall defines an opening.

19. The system of claim 1 further comprising additional mesofluidic separation sections operably coupled to the distal end of the length of opposing sidewalls.

20. The system of claim 1 wherein the one series of members comprises a plurality of linear members defining a grate, individual ones of the linear members extending in line as the series.

21. The system of claim 20 further comprising an expressway.

22. The system of claim 20 further comprising cross members.

23. A method for separating components of a mixture, the method comprising providing a mixture of components into a tortured path within a volume of at least one linear section of a conduit, the tortured path comprising at least one series of members extending in line across the volume from one sidewall of the volume and inwardly toward the distal end defining an angle other than normal from the one sidewall, the tortured path separating larger components from smaller components of the mixture to concentrate the larger components toward an opposing sidewall of the conduit.

24. The method of claim 23 wherein the one series of members comprises a plurality of posts, individual ones of the posts extending between opposing sidewalls of the conduit and defining individual cross sections, each of the cross sections being in line across the volume.

25. The method of claim 24 further comprising another series lateral of the one series.

26. The method of claim 25 wherein spacing between the posts of the one series is larger than the spacing between the posts of the other series.

27. The method of claim 24 further comprising at least one intermediate series between the one and the other series.

28. The method of claim 23 further comprising reducing turbulence of the mixture prior to the mixture engaging the tortured path.

29. The method of claim 22 further comprising providing the larger components to an expressway defined by at least a portion of the sidewalls.

30. The method of claim 22 further comprising providing components of the mixture having less larger components to additional mesofluidic separation sections operably coupled to a distal end of the section.

31. The method of claim 22 wherein the one series of members comprises a plurality of linear members defining a grate, individual ones of the linear members extending in line as the series.
